(19) United States
(12) Patent Application Publication
(10) Pub. No.: US 2007/0217978 A1
(43) Pub. Date: Sep. 20, 2007

(54) Minimization Of Pah Emissions During The Regeneration Of Particles Filters

(75) Inventors: Roman Baican, Offenbach (DE); Ronny Monnig, Wiesbaden (DE); Peter Zima, Mainz (DE)

Correspondence Address: INGRASSIA FISHER & LORENZ, P.C., 7150 E. CAMELBACK, STE. 325, SCOTTSDALE, AZ, 85251, US

(73) Assignees: GM GLOBAL TECHNOLOGY OPERATIONS, INC., Detroit, MI (US); FIAT AUTO S.P.A., Torino (IT)

(21) Appl. No.: 11/569,196

(22) PCT Filed: May 13, 2005
(86) PCT No.: PCT/EP05/05284

§ 371 Date: Nov. 16, 2006

(30) Foreign Application Priority Data
May 18, 2004 (DE) 10 2004 024 519.3

(51) Int. Cl. B01D 53/34; B01J 21/16

(52) U.S. Cl. 423/213.2; 423/212; 502/80

(57) ABSTRACT

According to the invention, the emission of polycyclic aromatic hydrocarbons (PAH) from the exhaust-gas system of diesel motors with particle filters can be minimized or prevented. During the regeneration of the particle filter, the polycyclic aromatic hydrocarbons (PAH) are first fixed in adsorption layers and are cracked there at high temperatures. The cracking products are then preferably eliminated in an oxidation step.

### CROSS-REFERENCE TO RELATED APPLICATIONS

This application is a U.S. National-Stage entry under 35 U.S.C. §371 based on International Application No. PCT/EP2005/005284, filed May 13, 2005, which was published under PCT Article 21(2) and which claims priority to German Application No. DE 10 2004 024 519.3, filed May 18, 2004.

### FIELD OF THE INVENTION

The present invention relates to a method for minimizing or preventing possible PAH emissions (PAH=polycyclic aromatic hydrocarbons) from particle filters during their regeneration or the greasing measures required for this, and also to catalyst arrangements suitable for conducting this method.

### BACKGROUND

The low-consumption diesel engine is essential today as vehicle drive system to assist in CO2 reduction and is likely to assume a significant share of the market in future in Europe (>60%). However, its high nitrogen oxide and soot particle emissions resulting from its principle of operation are a disadvantage, and apart from engine design measures these can only be prevented by expensive exhaust gas aftertreatments. Here, de-NOx systems and particle filter systems have been developed in recent years and have in part already been brought into series production. These systems are costly and, moreover, must in no way increase the risk of secondary emissions of the vehicle.

The advantages of modern diesel engines with exhaust gas turbocharge system and direct injection are low fuel consumption and high torque even in the lower speed range. These advantages appreciated by the end customers have led to a clear increase in market share in Europe in recent years. The 50% mark has already been exceeded in some countries. In Europe a market share of 50% on average is expected in 2005.

In spite of all the possible measures still available for optimizing engines such as two-stage supercharging, improved processing of the mix and even more precise control of combustion, for example, as well as in particular optimization of the dynamic method of operation, it is not to be expected that complex exhaust gas treatment will be omitted completely from diesel vehicles within the coming years.

In addition to soot, the polycyclic aromatic hydrocarbons (so-called PAHs) deposited thereon as well as sulfates, water and metal oxides from engine wear and oil additives are formed during the combustion of diesel fuel. Oxidation catalysts currently in use convert a large portion of the deposited hydrocarbons (so-called SOFs) in addition to combustible gaseous components (CO and CH) and thus contribute to a slight reduction in particle emissions (<30% mass). The conventional catalyst technology is today not capable of chemically eliminating very complex particles completely. The only reliable method at present of trapping particles (grains of soot) lies in filtering these by means of suitable filter elements and in their subsequent combustion (regeneration).

Various filter technologies have been developed for filtering soot particles and additions deposited on them. Here, the following typical structural forms are distinguished:

Honeycomb filters (ceramic cell filters) are produced from cordierite, silicon carbide (RSiC), mullite or other ceramic materials using the extrusion process. With these filters, the flow of exhaust gas is forced through the filter wall, and as a result the soot particles can be filtered out and a soot layer is formed, which causes a defined exhaust gas counterpressure over time.

Candle filters are made from ceramic fibers, which are wound to form a filter candle. The fibers are composed of silicon oxide or aluminum oxide and are specially treated to improve filtration. During flow through the filter candles the particles are deposited between the fibers by adhesion forces and impact, wherein no soot layer is formed as a general rule (so-called deep-bed filters).

For sintered metal filters, metal fibers are sintered together to form filter plates. During flow through the filter plate the soot particles are deposited onto its surface (surface filters).

For foam filters, foam bodies are produced from aluminum oxide or silicon carbide (SiC), through which the exhaust gas flows, soot particles being deposited in the structure. The filter efficiency can be controlled via the pore size, but is generally inadequate for requirements in the automotive field.

The deposited soot must be removed continuously or periodically, irrespective of the filter design. For this, the filter temperatures are generally briefly increased to values, which allow a reliable and quick combustion of the trapped carbon particles.

For efficient combustion of a soot particle, temperatures above 620° C. are required, which are difficult to attain in the diesel exhaust gas itself in full load operation (e.g. during uphill travel with trailer load). Therefore, additional energy must be supplied in order to set the regeneration conditions, wherein a discontinuous loading and regeneration process is generally adhered to. There are various possibilities for provision of the necessary energy such as the after-injection of fuel and subsequent exothermic reactions in the Oxicat, the use of electrical heaters or other ignition aids, the use of (fuel) burners as well as non-thermal plasma (NTP) processes, in which the soot is principally regenerated through oxidation with O-radicals.

Corresponding processes and devices are described in the prior art. Thus, WO96/24755 A1 discloses a device for reducing the quantity of discharging soot particles in diesel internal combustion engines comprising a container with a gas inlet and gas outlet connection and a hollow body, which is partially filled with a knitted fabric of filter material, wherein a catalytic additive is supplied to the fuel upstream of the internal combustion engine and the filter material has a plurality of knitted ceramic bundles, wherein the ceramic bundles are knitted tubes of superfine ceramic threads rolled up from one end, which are drawn through by a heat-resistant wire, wherein the coarse stitch width of the tube has a specific magnitude and the heat-resistant wire passes through each individual stitch of the knitted fabric.

Patent document U.S. Pat. No. 6,912,847 describes low-temperature NO2 traps for the absorption of NO2 from a gas stream at lower temperatures and the release of NO2 at higher temperatures. The low-temperature NO2 traps are suitable for installation in a diesel exhaust system equipped with a soot filter. The NO2 of the diesel exhaust gas can be stored when the exhaust gas temperature is cool, e.g. during the start phase as well as with low load, and can be released at higher exhaust gas temperatures. The released NO2 serves as an effective oxidising agent for the combustion of the soot deposited on the soot filter. These temperatures are significantly lower than those required for combustion of the soot with O2 as oxidising agent.

The patent document DE 102 18 232 A1 describes a method for improving the effectiveness of diesel fuel injected into the exhaust gas train of an internal combustion engine for NOx reduction before an SCR catalyst and a catalyst design for conducting the method. A method and also a catalyst suitable for it are described, with which an effective and reliable dosage of diesel fuel is assured with extremely low consumption. For this, the diesel fuel used is converted by partial catalytic cracking into a more active form before the nitrogen oxides are converted in a process preceding the SCR reaction. A catalyst suitable for conducting this method has zeolites or mesoporous and/or pillared aluminosilicates as the basis for both coatings.

European patent specification EP-B-0 703 352 discloses an exhaust gas emission control system with a particle collector filter, wherein the filter respectively has at least one catalyst in its portion located upstream in the flow of a regenerative gas and in its portion located downstream, and which is regenerated by using this regenerative gas, which contains the fuel, wherein the control system comprises a means for determining when the filter must be regenerated. In the case of this filter, the control system comprises a partial combustion control means for effecting the particle combustion in only the portion of the filter located downstream in the flow of the regenerative gas by controlling the temperatures, so that combustion of the fuel in the regenerative gas in only effected in the portion of the filter located downstream when the filter has to be regenerated; and comprises a combustion propagation control means to cause the particle combustion in the portion of the filter located downstream to be propagated to the portion of the filter located upstream in the flow of the regenerative gas by the fuel being combusted in the regenerative gas at the catalyst in the portion of the filter located upstream.

The health risk resulting from diesel soot is acknowledged to be attributable to the above-mentioned deposits, wherein in particular polycyclic aromatic hydrocarbons (PAHs), and of these the PAHs from the group comprising naphthalene, acenaphthylene, acenaphthene, fluorene, phenanthrene, anthracene, fluoranthene, pyrene, benz(a)anthracene, chrysene, benzo(b)fluoranthene, benzo(f)fluoranthene, benz(a)pyrene, dibenz(ah)anthracene, benzo(ghi)perylene and indenopyrene, besides the nitro PAHs, are classed as particularly dangerous.

During the regeneration of the particle filter, the temperature must be increased to temperatures above 620° C., as stated above. Because of the high thermal capacity of the engine and also the entire exhaust gas system, this temperature is only reached in the entire filter with a considerable time delay, and this consequently leads to a slow heating of the filter.

There is the risk here that besides other additions (e.g. SOFs), the PAHs are principally desorbed prematurely from the soot particles and discharged from the exhaust gas system with the exhaust gas flow, since the combustion temperature of the PAHs cannot be reached from the outset. The filter effect would then be counterproductive for the effective filtering of substances harmful to health.

Therefore, the object forming the basis of the present invention is to provide a catalyst as well as a method that minimizes or prevents the discharge of PAHs from the exhaust gas system.

### BRIEF DESCRIPTION OF THE DRAWINGS

The present invention will hereinafter be described in conjunction with the following drawing figures, wherein like numerals denote like elements, and

FIG. 1 is a schematic representation of a diesel particle filter in a first embodiment;

FIG. 2 is a schematic representation of a diesel particle filter in a second embodiment; and

FIG. 3 is a schematic representation of a diesel particle filter in a third embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

According to the invention, a method is provided for reducing the emissions of diesel-operated engines with particle filters, wherein in the regeneration of the particle filter the polycyclic aromatic hydrocarbons (PAHs) are firstly fixed in adsorption layers and are cracked there at higher temperatures (with a time delay). The thus resulting cracking products of the PAHs can be easily broken down with oxidation catalysts of known structural type.

The method according to the invention leads to a clear decrease in the possible PAH emissions and thus to the reduction of any health risks in the regeneration of diesel particle filters, and already in the preceding process of greasing the engine leads to the desired increase in exhaust gas temperatures. In addition, the method is distinguished by a high flexibility, which allows it to be adapted to all conventional filter systems. In this case, it is additionally advantageous that the method according to the invention has a high insensitivity to sulfer, so that it is also safe for use in countries with lower quality fuel.

According to the invention, after their desorption from the soot particles the PAHs are fixed in suitable adsorption layers in the filter material or on separate bricks after this without being able to pass into the environment with the exhaust gas flow. With the time-delayed increase in temperature in the filter, the PAHs are converted (principally cracked) into low-molecular and easily destroyed compounds.

Naturally based adsorption layers (i.e. that can be degraded in nature), for example, are conceivable as adsorption layers that can be used in the method according to the invention. Preferred adsorption layers in this case are modified clay minerals, in particular modified clay minerals from the smectite group. Montmorillonite, the main constituent of bentonite, is the most important representative of these minerals. However, the more costly synthetic representatives of mesoporous molecular sieves such as M41S, or hydrophobic, more temperature-insensitive zeolites are also conceivable for this application.

In methods preferred according to the invention, the adsorption is conducted on adsorption layers composed of mineral adsorbents and catalysts, preferably composed of modified clay minerals, and particularly preferred those composed of modified clay minerals from the smectite group, or silicates related to M41S.

The term bentonites refers to argillaceous rocks formed by the weathering of volcanic ash. The properties of bentonites are determined by the clay mineral montmorillonite. What distinguishes them in particular and renders them advantageously usable is their excellent capability to undergo pillaring processes, i.e. the purposeful expansion of the silicate layer structure. Montmorillonite is an aluminium hydrosilicate (sheet silicate), which belongs to the group of phyllosilicates. Montmorillonite is the main representative in the group of (dioctahedral) sheet silicates, which are also referred to as smectites. In practice, bentonite, smectite and montmorillonite are therefore used as synonyms for multilayered silicates that are capable of swelling. Moreover, bentonite can include accompanying minerals such as quartz, feldspar, mica.

A montmorillonite crystal is configured from about 15 to 20 elementary layers. Located between these layers, besides the water of crystallisation, are exchangeable cations, which compensate the negative excess charges of the lattice (tetravalent aluminium). These are loosely bonded to the lattice and can be replaced by other cations or also by positively charged organic molecules (e.g. alkyl ammonium salts). Bentonites or montmorillonites have a marked ability for ion exchange and for the inclusion of organic, generally highly polar particles. The specific surface area of montmorillonite can amount to up to 800 m2/g in the pillared state. Often only 300-400 m2/g are achieved in practice, which is mainly caused by structural defects.

The following bentonites are distinguished: calcium bentonite, wherein the smectite group is coated almost exclusively with Ca2+ or Mg2+ ions in the intermediate layers; sodium bentonite (natural bentonite), wherein the smectite group is predominantly coated with Na2+ ions in the intermediate layers, but Ca2+ or Mg2+, NH4+ ions can also be present in different quantities; activated bentonite, originally a calcium bentonite, wherein the original cation coating of the intermediate layers is exchanged through Na+ ions by means of alkaline activation; acid-activated bentonite, wherein the smectite group is partially dissolved in association with acids in a special process, wherein large surface areas are created; organo-bentonite, wherein the cations of the intermediate layers are exchanged for polar organic molecules (such as quaternary ammonium compounds). The bentonite can also swell in polar liquids as a result of this hydrophobisation.

The specified modified clay minerals, in particular the modified clay minerals from the smectite group, and of these, montmorillonite, have proved to be very well suited to the adsorption/inclusion of PAHs that can be desorbed from the soot. On the other hand, they are capable of efficiently cracking the trapped PAHs with increasing temperatures. In this case, the method according to the invention is preferably conducted so that low-molecular and therefore easily degradable (Oxicat) compounds are products of the cracking process. In the framework of the present invention, methods are preferred, in which the catalytic cracking is characterized by selective formation of an HC(O) fraction (chain length) with 2-6 carbon atoms.

Alternatively to the above-mentioned modified clay minerals or supplementary to these, acid zeolites and other tectosilicates (solid acids) such as M41S, can also be used as adsorbent for PAHs.

The activated hydrophobic zeolites have an MFI structure, wherein ZSM zeolites such as ZSM-5 are preferred. These have the general total formula [Nan(H2O)16] [A1nSi96-nO192]−MFI, n<27. The modification increasing the activity can consist of, on the one hand, exchanging the sodium ions completely or partially for H+ to thus obtain acid zeolites, and on the other hand the zeolites can also be modified by metal loading. The zeolites that can be used as adsorption layer include in particular acid, metal-modified (Cu, Fe) and therefore oxidation-active zeolites, wherein the use of expensive and (through discharge) toxic noble metals becomes unnecessary.

Mesoporous, amorphous, silicate and aluminosilicate MCM-41 materials are also preferred as adsorption layers. The hexagonal MCM-41 phase, which belongs to the family of M41S materials, has mesopores with diameters in the range of 2 nm to 10 nm and has a specific surface area of more than 1000 m2/g.

In methods particularly preferred according to the invention, the H(O)C fraction formed by the cracking process is not directed into the environment with the exhaust gas flow, but is oxidized to form water and carbon dioxide. Methods according to the invention, wherein the cracked HC fraction is directed over an oxidizing coating in a further step, are preferred according to the invention.

Preferred methods according to the invention are characterized in that the two steps (adsorption with subsequent cracking as well as oxidation of the products) are conducted on a catalyst. For this, the PAHs are firstly adsorbed and then cracked, and the cracking products are then directed over an oxidation catalyst. In preferred methods according to the invention, the two steps are presented as multi-brick systems or zone coating on one catalyst.

The present invention additionally relates to a diesel particle filter (DPF) for undertaking the exhaust gas purification method according to the invention. Such a DPF has at least one component, which is capable of effectively trapping PAHs and of chemically converting these with a subsequent increase in temperature in a suitable manner. For this, both the catalytic cracking and an optional subsequent oxidation are expediently conducted within a structural part.

A diesel particle filter (DPF) according to the invention for conducting the method according to the invention is characterized in that it has at least adsorption layers composed of zeolites and/or mesoporous and/or pillared clay minerals.

The adsorbing and cracking material can be arranged directly inside the particle filter in this case (e.g. by coating of the gas outlet ducts). However, it can also be contained in a separately arranged additional catalyst brick, if (lacking) temperature stability of the selected material does not allow this.

A filter/catalyst design with a high cell density substrate can also be used, wherein the coating types for the adsorption and subsequent cracking are applied in a specific arrangement along the carrier. A catalyst design using zone technique is particularly suitable, in which more adsorbing and cracking coating is applied on the catalyst inlet and locally more oxidizing coating is applied towards the catalyst outlet. In principle, however, no restrictions are made for the distribution of the catalyst on the carrier (separate zones, multi-brick system or zone arrangement). If the catalytically active compounds are used as basis for the catalyst for cracking the hydrocarbons, in particular the mineral carriers, preferably modified clay minerals, particularly preferred modified clay minerals from the smectite group, such a zone arrangement can be achieved by merely applying a coating to the carrier for oxidation of the hydrocarbons formed.

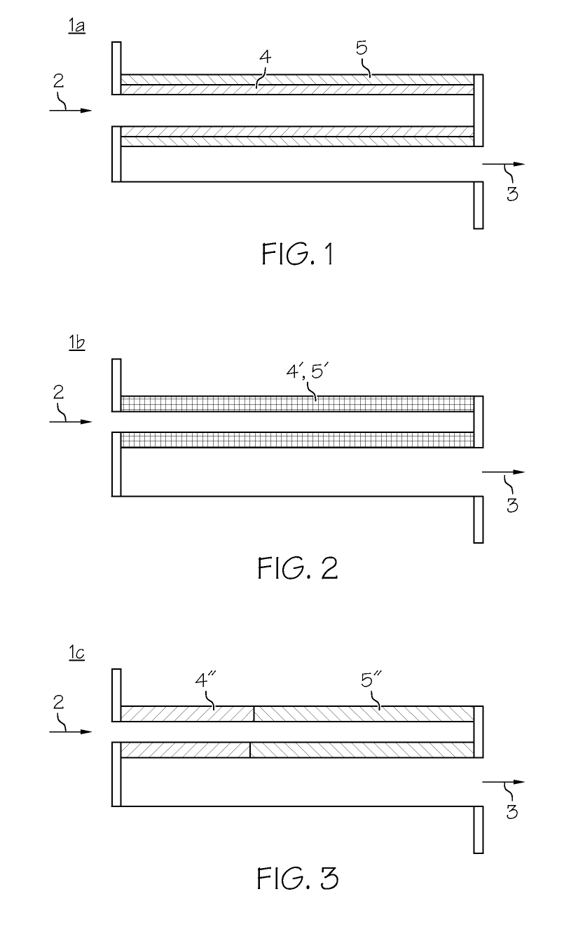

According to FIG. 1, a diesel particle filter la for conducting the method according to the invention has an adsorption layer 4 on the side of inflowing exhaust gas 2, while an oxidising coating 5 is provided on the side of the exhaust gas 3 flowing out of the diesel particle filter la. Thus, all the exhaust gas firstly flows through the adsorption layer 4 and then the oxidizing coating 5 of the diesel particle filter 1a.

According to FIG. 2, a diesel particle filter 1b is fitted with a composite coating, combining the adsorption layer 4′ and the oxidizing coating 5′ within it, arranged between the inflowing exhaust gas 2 and the outflowing exhaust gas 3.

According to FIG. 3, coatings according to the invention are applied to a diesel particle filter 1c in a specific arrangement along the longitudinal extent of the diesel particle filter 1c in such a manner that the adsorption layer 4″ is provided on the side of inflowing exhaust gas 2 at the catalyst inlet and the oxidizing coating 5″ is applied on the side of outflowing exhaust gas 3 at the catalyst outlet.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. Method for reducing the emissions of diesel-operated engines with particle filter in the regeneration of the particle filter the polycyclic aromatic hydrocarbons (PAHs) are firstly fixed in adsorption layers and are cracked there at higher temperatures.

2. Method according to claim 1, wherein the adsorption is conducted on adsorption layers composed of mineral catalysts, preferably of modified clay minerals, particularly preferred of modified clay minerals from the smectite group.

3. Method according to claim 1, wherein the adsorption is conducted on adsorption layers comprising acid zeolite catalysts (solid acids).

4. Method according to claim 1, wherein the cracked HC fraction is directed over an oxidizing coating in a further step.

5. Method according to claim 4, wherein both steps are presented as multi-brick systems or zone coating on one catalyst.

6. Diesel particle filter (DPF) for conducting the method according to claim 1, wherein it has adsorption layers composed of zeolites and/or mesoporous and/or pillared clay minerals.

7. Diesel particle filter according to claim 6, wherein a catalyst design with a high cell density substrate, wherein the coatings for the adsorption and the subsequent cracking are applied in a specific arrangement along or transversely to the carrier.

8. Diesel particle filter according to claim 6, wherein a catalyst design using zone technique, wherein more adsorbing and cracking coating is applied at the catalyst inlet in the region of the inflowing exhaust gas and more oxidizing coating is applied locally towards the catalyst outlet in the region of the outflowing exhaust gas (3).
